(19) United States
(12) Patent Application Publication
(10) Pub. No.: US 2009/0063626 A1
(43) Pub. Date: Mar. 5, 2009

(54) CALL MANAGEMENT SYSTEM, CALL MANAGEMENT METHOD, MANAGEMENT SERVER, CLIENT SERVER, CLIENT TERMINAL, AND CALL DEVICE

(76) Inventors: Kazushi Nakagawa, Fujisawa (JP); Takatoshi Kato, Takatoshi Kato (JP); Takashi Tsunehiro, Ebina (JP); Hiroshi Kodaka, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/198,930

(22) Filed: Aug. 27, 2008

(30) Foreign Application Priority Data
Aug. 27, 2007 (JP) 2007-219968

(51) Int. Cl. G06F 15/16; G06F 7/58

(52) U.S. Cl. 709/203; 726/4

(57) ABSTRACT

A call management system is configured of a client terminal 200 and a management server 100. The client terminal 200 executes a presence detection process by communicating with a call device 50 and acquiring presence information including a user ID, and a presence transmission process of transmitting, to a management server 100, presence information including the presence information of the detected user and the ID of the client terminal 200 itself. The management server 100 executes a presence acquiring process of receiving the presence information and storing the information in a user management table; a coupling destination reading process of, upon receipt of a call originated by a communication terminal 30, reading the presence information of a user corresponding to a telephone number of a call destination and information on an assigned client server 300, from the user management table as coupling destination information; and a coupling request process of transmitting, to the assigned client server 300, a call coupling request which includes coupling information of the communication terminal, and which requests establishment of a call between the communication terminal 30 and the call device 50.

### INCORPORATION BY REFERENCE

This application claims priority based on a Japanese patent application, No. 2007-219968 filed on Aug. 27, 2008, the entire contents of which are incorporated herein by reference.

### BACKGROUND OF THE INVENTION

The present invention relates to a call management system, a call management method, a management server, a client server, a client terminal, and a call device. Specifically, the present invention relates to a technique for managing IP calls based on the presence of users in a thin client system.

A concept known as “thin client” has appeared out of necessity for measures against information leakage and for internal control on information in companies and the like. The concept employs as a client computer a dedicated computer (a thin client) provided with minimum functions such as display and input while not including a hard disk device and the like, and uses a server (a blade server) for centrally managing resources such as application software.

As a technique related to such a thin client system, Japanese Patent Application Laid-open Publication No. 2006-254411 (referred to as Document 1 below) proposes an IP communication system under an object of providing a thin client (TC) system in which at least a thin client terminal is used as a telephone terminal, for example. In the proposed XP communication system, a client server for managing data and a data creation program; a client terminal capable of controlling the client server remotely; a network coupling the client terminal and the client server; a communication terminal capable of transmitting/receiving or distributing sound and images; and communication establishing means for establishing communication with the communication terminal are coupled to the network. The IP communication system is provided with communication control means for establishing communication with any one of or both of the client terminal and the client server. In this system, when communication is established between the client terminal and the communication terminal by use of the communication control means, first communication attribute information indicating the communication capacity of the client terminal is transmitted to the communication terminal through the client server and the communication establishment means. At the same time, second communication attribute information indicating the communication capacity of the communication terminal is transmitted to the client terminal through the communication establishment means and the client server. Here, the communication between the client terminal and the communication terminal is established on the basis of these pieces of communication attribute information, and the network configures a communication path between the client terminal and the communication terminal. According to the invention, communication can be established between the thin client terminal and the communication terminal without passing through a thin client server, that is, communication can be established in P-to-P.

### SUMMARY OF THE INVENTION

As has been described, the conventional technique proposes the communication technique for P-to-P in a thin client system. However, further improvement is desired for a technique enabling management of calls between a client terminal and a communication terminal (a client terminal or an external telephone terminal) based on the presence of a user, by managing the presence.

The present invention is made in view of the above-mentioned problem, and provides a technique for enabling management of calls based on the presence of a user, in a thin client system.

A call management system of the present invention for solving the above problem is a call management system including a client server; a client terminal which remotely controls the client server; and a management server which manages communication between a call device coupled to the client terminal and a communication terminal, the client server and the client terminal constituting a thin client system. The client terminal executes a presence detection process of detecting the presence of a user by communicating with the call device held by the user and by acquiring presence information including a user ID stored in the call device; and a presence transmission process of transmitting, to the management server, presence information including the presence information of the user detected by the presence detection, and also including the ID of the client terminal itself which has detected the presence. The management server includes a user management table which stores an ID, a telephone number and presence information of each user as well as information on the assigned client server in association with each other. The management server executes a presence acquiring process of receiving the presence information transmitted from the client terminal, and storing the presence information in the user management table in association with an appropriate user; a coupling destination reading process of, upon receipt of a call originated by the communication terminal, reading presence information of a user corresponding to a phone number of a call destination of the originated call and information on the assigned client server, from the user management table as coupling destination information; and a coupling request process of transmitting, to the assigned client server designated by the coupling destination information, a call coupling request which includes coupling information of the communication terminal included in the originated call, and which requests establishment of a call between the communication terminal and the call device held by the user and coupled to the client terminal indicated by the presence information of the coupling destination information.

In the call management system, the client server may include a terminal management table storing the coupling destination information of an assigned client terminal. The client server may execute; an incoming call process of receiving the call coupling request transmitted from the management server and causing the call device to receive a call through the client terminal; and a call process of, upon receipt of a call answer from the call device in response to the incoming call through the client terminal, notifying the communication terminal of the coupling destination information of the client terminal read from the terminal management table through the management server, and establishing a call between the call device and the communication terminal.

In the call management system, in the call process, the client server may acquire a port number corresponding to the call device from the client terminal, notify the communication terminal of the coupling destination information of the client terminal read from the terminal management table and the port number through the management server, and establish a call between the call device and the communication terminal.

In the call management system, the client terminal may execute a coupling destination notification process of notifying the call device held by the user detected by the presence detection, of the coupling destination information of the client server to which the client terminal is assigned. The call device may; execute a coupling destination acquiring process of receiving the coupling destination information of the client server transmitted from the client terminal, and storing the information in a storage; and transmit the presence information including the user ID and the coupling destination information of the client server which is stored in the storage, when communicating with the client terminal in the presence detection process.

In the call management system, the client server may exchange call data between the communication terminal and the call device coupled to the client terminal. Assume a case where the call device which had been communicating with the communication terminal by being coupled to a client terminal A travels, and as a result, becomes capable of being coupled to a client terminal B. Here, the client terminal B may execute the presence detection process to acquire the presence information including the user ID stored in the call device; and execute the presence transmission process to transmit, to the management server, presence information including the presence information of the detected user, and also including the ID of the client terminal B itself which has detected the presence. The management server may execute a roaming occasion detection process of executing the presence acquiring process to receive the presence information transmitted from the client terminal B, storing the presence information in the user management table in association with an appropriate user, referring to communication status data between the call device and the client terminals A and B, which is included in each piece of the presence information of the user in the user management table, and detecting a roaming occasion in which a communication status between the call device and the client terminal B is better than a communication status between the call device and the client terminal A by a specified level or higher; and a roaming process of, when the roaming occasion is detected, transmitting a roaming instruction to the client server assigned to the client terminal A, so that calls between the communication terminal and the call device can be established through the client terminal B instead of through the client terminal A.

In the call management system, a call device a of a user A may communicate with the client terminal, transmit authentication information provided in its own storage to the client terminal as an authentication request, and execute a process of establishing a call with the client terminal according to an authentication result based on the authentication request acquired from the client terminal. Upon receipt of the authentication request from the call device a, the client terminal may execute a device authentication process of checking the authentication information against the authentication information provided in its own storage, and returning the authentication result to the call device a. The client terminal may receive a login request including user authentication information from the user A of the call device a through an input interface, may transmit a user authentication request including the user authentication information contained in the login request to the call device a, and executes a login process for the user and an initiation process of remote control over a client server, when the authentication result based on the user authentication request made by the call device a is valid. Assume a case where a call device b of a user B is coupled to the client terminal to which the user A is logged in. Here, the client terminal may secure a communication port for the call device b to communicate, and execute the presence detection process and the presence transmission process for the call device b. Additionally, the management server may execute the presence acquiring process, the coupling destination reading process, and the coupling request process for the call device b.

In the call management system, the client terminal to which the user A is logged in or the client server which is remotely controlled by the client terminal may detect a logoff process of the user A from the client terminal, then, upon this detection, confirm the call device b on a call with the communication terminal through the client terminal, and notify the call device b of a call termination notice.

In the call management system, the client server may: store, in a storage, telephone directory data which is a coupling destination information list of a called party of the call device, and may execute a telephone directory output process of detecting that a call device is coupled to the client terminal coupled to the client server itself, reading the telephone directory data from the storage, and outputting the data to the call device through the client terminal. The call device may execute a telephone directory acquiring process of receiving the telephone directory data transmitted from the client server through the client terminal and storing the data in a storage; and a telephone directory deletion process of detecting that communication with the client terminal is terminated, and deleting the telephone directory data in the storage.

In addition, in a call management method of the present invention, a thin client system includes a client server and a client terminal which remotely controls the client server, a management server manages communication between a call device coupled to the client terminal and a communication terminal and includes a user management table for storing an ID, a phone number and presence information of each user an well as information on the assigned client server in association with each other. The method comprises executing by the client terminal a presence detection process of detecting the presence of a user by communicating with a call device owned by a user, and by acquiring presence information including a user ID stored in the call device; and a presence transmission process of transmitting, to a management server, presence information including the presence information of the user detected by the presence detection, and also including the ID of the client terminal itself which has detected the presence. The method also comprises by the management server executing a presence acquiring process of receiving the presence information transmitted from the client terminal, and storing the presence information in the user management table in association with an appropriate user; a coupling destination reading process of, upon receipt of a call originated by the communication terminal, reading the presence information of a user corresponding to a phone number of a call destination of the originated call and information on the assigned client server, from the user management table as coupling destination information; and a coupling request process of transmitting, to the assigned client server designated by the coupling destination information, a call coupling request which includes coupling information of the communication terminal included in the originated call, and which requests establishment of a call between the communication terminal and the call device owned by the user and coupled to the client terminal indicated by the presence information of the coupling destination information.

Additionally, a management server of the present invention communicates with a client server in a thin client system, and manages calls between a call device coupled to a client terminal which controls the client server remotely and a communication terminal. The management server comprises a communication interface for communicating with the client server and the communication terminal; a storage storing a user management table which stores an ID, a telephone number, and presence information of each user as well as information on the assigned client server in association with each other; and a processor. The processor executes a presence acquiring process of receiving, from the client terminal, presence information including a user ID that the client terminal has acquired from the call device coupled to itself and the ID of the client terminal itself, and storing the information in the user management table in association with an appropriate user; a coupling destination reading process of, upon receipt of a call originated by the communication terminal, reading presence information of a user corresponding to a telephone number of a call destination of the originated call and information on the assigned client server, from the user management table as coupling destination information; and a coupling request process of transmitting, to the assigned client server designated by the coupling destination information, a call coupling request which includes coupling information of the communication terminal included in the originated call, and which requests establishment of a call between the communication terminal and the call device held by the user and coupled to the client terminal indicated by the presence information of the coupling destination information.

Note that the Session Initiation Protocol (SIP) can be assumed as the protocol used to control calls between the call device and the communication terminal in the present invention. SIP is one of communication protocols used in an Internet phone and the like to which VoIP is applied, and is a method for converting voice to IP packets to handle the voice on various kinds of IP networks such as a LAN and the Internet. Accordingly, a SIP server managing calls based on SIP can be assumed as an actual example of the management server.

In addition, a client server of the present invention is a client server which is controlled remotely from a client terminal in a thin client system, and which is capable of communicating with a management server for managing calls between a communication terminal and a call device coupled to the client terminal. The client server comprises a communication interface for communicating with the client terminal and the management server; a storage storing a terminal management table which stores the coupling destination information of the client terminal assigned to the client server itself; and a processor. The processor executes an incoming call process of receiving a call coupling request made by the management server to request a call establishment process for a call between the call device coupled to the client terminal assigned to the client server itself and the communication terminal originating a call toward the call device, and causing the call device to receive the call through the client terminal; and a call process of, upon receipt of a call answer from the call device in response to the incoming call through the client terminal, notifying the communication terminal of the coupling destination information of the client terminal read from the terminal management table through the management server, and establishing a call between the call device and the communication terminal.

Additionally, a client terminal of the present invention is a client terminal which remotely controls a client server in a thin client system, and which is capable of communicating with a call device held by a user. The client terminal comprises a communication interface for communicating with the call device; a storage; and a processor. The processor executes a presence detection process of detecting the presence of the user by communicating with the call device held by the user and by acquiring presence information including a user ID stored in the call device, and then storing the presence information in the storage; and a presence transmission process of reading the presence information of the user detected by the presence detection from the storage, generating presence information including the presence information of the user, and also including the ID of the client terminal itself which has detected the presence, and transmitting the generated information to the management server.

Moreover, a call device of the present invention is a call device capable of communicating with a client terminal which remotely controls a client server in a thin client system. The call device comprises a communication interface for communicating with the client terminal; a storage storing a user ID of the call device; and a processor. The processor executes a process of transmitting the user ID stored in the storage to the client terminal as presence information when communicating with the client terminal; a process of outputting an incoming call notice to a predetermined output interface upon receipt of an incoming call process by the client server through the client terminal; a process of receiving an instruction for a call answer in response to the incoming call from an input interface, and returning information on the call answer to the client terminal; and a process of executing the transmission and reception of call data from and to a communication terminal if a call is established with the communication terminal that has originated the incoming call.

Note that although the communication terminal is assumed to originate a call, the client terminal may be assumed as the communication terminal originating the call in the scope of claims, descriptions are provided of processes in response to a call originated by the communication terminal. However, the processes may be understood as those based on a call originated by the client terminal, as a matter of course.

Additionally, a technique disclosed in Document 1 may be adopted as a base for the P-to-P communication technique to be used between the call device and the communication terminal through the client terminal.

The problem and solving means disclosed in this application will be made clear in the section of detailed description of the preferred embodiment and through the accompanying drawings.

The present invention enables call management based on the presence of a user in a thin client system.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a network configuration diagram of a call management system of an embodiment.

FIG. 2 is a view showing a configuration example of a management server of the embodiment.

FIG. 3 is a view showing a configuration example of a client terminal of the embodiment.

FIG. 4 is a view showing a configuration example of a client server of the embodiment.

FIG. 5 is a view showing a configuration example of a call device of the embodiment.

FIG. 6A is a view showing a data configuration example of a user management table of the embodiment.

FIG. 6S is a view showing a data configuration example of a server management table of the embodiment.

FIG. 6C is a view showing a data configuration example of a terminal management table of the embodiment.

FIG. 6D is a view showing a data configuration example of telephone directory data of the embodiment.

FIG. 6E is a view showing a data configuration example of device management table of the embodiment.

FIG. 7 is a view showing a first exemplary process flow of the call management method of the embodiment.

FIG. 8 is a view showing a second exemplary process flow of the call management method of the embodiment.

FIG. 9 is a view showing a third exemplary process flow of the call management method of the embodiment.

FIG. 10 is a view showing a fourth exemplary process flow of the call management method of the embodiment.

FIG. 11 is a view showing a fifth exemplary process flow of the call management method of the embodiment.

FIG. 12 is a view showing a sixth exemplary process flow of the call management method of the embodiment.

### DETAILED DESCRIPTION OF THE EMBODIMENTS

### System Configuration

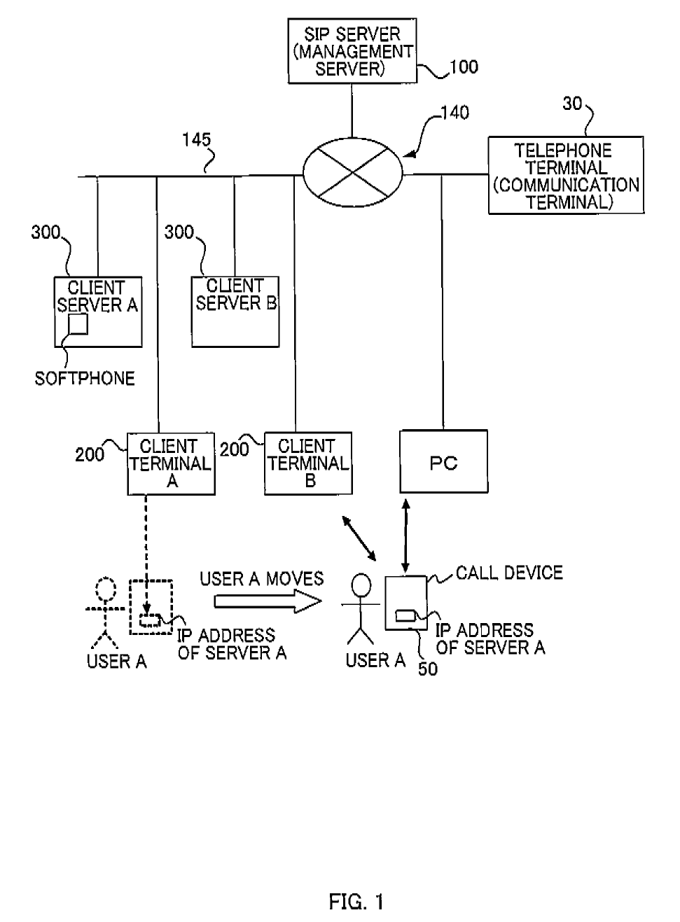

A detailed description will hereinafter be given of an embodiment of the present invention with reference to the accompanying drawings. FIG. 1 is a network configuration diagram of a call management system of the embodiment. A call management system 10 shown in FIG. 1 includes multiple client servers 300 coupled to each other through a network; client terminals 200 controlling the client servers 300 remotely; a call device 50 coupled to the client terminal 200; a communication terminal 30 communicating with the call device 50; and a SIP server 100 (hereinafter referred to as the SIP server 100) being a management server which manages calls between the call device 50 and the communication terminal 30.

Moreover, the SIP server 100, the client terminals 200, and the client servers 300 are coupled to a local area network (LAN) 145 which is an internal network constructed in a company and the like. The LAN 145 is coupled to a network 140 such as a wide area network (WAN) via a router. The communication terminal 30 originates a call to the SIP server 100 through the network 140. This network configuration is merely an example, and various other network configurations may be adopted, as a matter of course.

Note that the client server 300 forms a virtual private network (VPN) between itself and the client terminal 200. Through the VPN, the client server 300 receives and processes input information (the operation contents of an input apparatus) transmitted from the client terminal 200, as well as transmits image information (a desktop screen of a display device) showing the process result to the client terminal 200. The client server 300 is a server apparatus which generally uses input/output apparatuses without coupling to the input/output apparatuses locally.

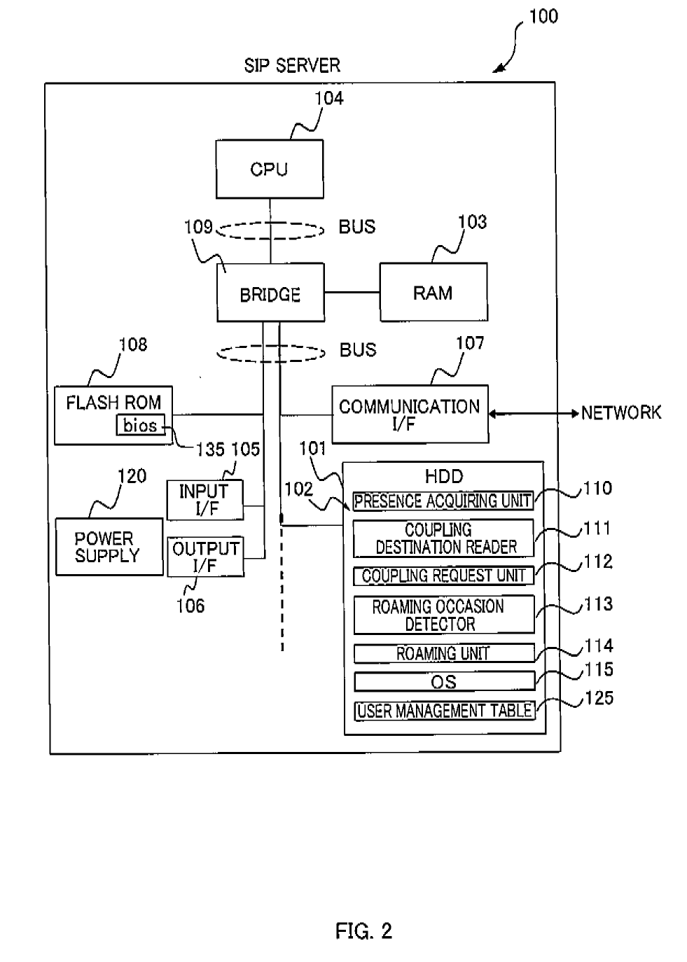

Next, a description will be given of each apparatus constituting the call management system 10 of the embodiment. FIG. 2 is a view showing a configuration example of the SIP server 100 of the embodiment. The SIP server 100 is a server apparatus for controlling calls in accordance with the Session Initiation Protocol (SIP) which is a protocol for controlling calls between the call device 50 and the communication terminal 30. Furthermore, the SIP server 100 loads, to a RAM 103, each of programs 102 stored in a hard disk drive 101 and the like to implement a function of the present invention, and executes the program with a CPU 104 which is a processor.

In addition, the SIP server 100 has: input interfaces 105 such as various buttons which are generally provided to a computer apparatus; an output interface 106 such as a display if necessary; and a communication interface 107 for exchanging data with apparatuses such as the client terminal 200, the client server 300 and the communication terminal 30; and the like.

Moreover, the SIP server 100 has a flash ROM 108, a bridge 109 for interconnecting buses coupling each of the components, and a power supply 120.

Note that the flash ROM 108 stores a BIOS 135. After turning on the power supply 120, the CPU 104 firstly accesses the flash ROM 108 to execute the BIOS 135, thereby identifying a system configuration of the SIP server 100. Additionally, the hard disk drive 1101 stores an OS 115 in addition to each function unit, table, and the like. The OS 115 is a program for the CPU 140 to perform centralized control over the components of the SIP server 100, and to execute each function unit to be described later. In accordance with the BIOS 135, the CPU 104 loads the OS 115 from the hard disk drive 101 to the RAM 103 for execution. Thus, the CPU 104 performs centralized control over the components of the SIP server 100.

Next, a description will be given of function units configured and held by the SIP server 100 based on the programs 102, for example. Note that the SIP server 100 is assumed to have a user management table 125 which stores, for each user, an ID, a telephone number, presence information and information on an assigned client server in association with each other in an appropriate storage device such as a hard disk.

The SIP server 100 has a presence acquiring unit 110 which receives, from the client terminal 200, presence information including a user ID that the client terminal 200 has acquired from the call device 50 coupled to itself, and the ID of the client terminal 200 itself. Thereafter, the presence acquiring unit 110 stores the presence information in the management table 125 in association with the appropriate user.

Moreover, the SIP server 100 has a coupling destination reader 111 which reads the following pieces of information as coupling destination information, in response to a call originated by the communication terminal 30. Specifically, the coupling destination reader 111 reads presence information of a user corresponding to a telephone number of a call destination of the originated call, and information of the assigned client server 300 from the user management table 125.

In addition, the SIP server 100 has a coupling request unit 112 for transmitting a call coupling request to the assigned client server 300 contained in the coupling destination information. The call coupling request includes coupling information of the communication terminal 30 included in the call, and requests establishment of a call between the communication terminal 30 and the call device 50 of the user coupled to the client terminal 200 indicated by the presence information of the coupling destination information.

Generally, when a call between the call device 50 and the communication terminal 30 is established, the call data therebetween is exchanged in P-to-P. However, it is possible to assume a situation where the client server 300 processes the exchange of call data between the communication terminal 30 and the call device 50 coupling to the client terminal 200. At this point, suppose that the call device 50 which is communicating with the communication terminal 30 by being coupled to a client terminal A travels, and as a result, becomes capable of being coupled to another client terminal B.

In this case, the presence acquiring unit 110 of the SIP server 100 receives presence information transmitted from the client terminal B, and stores the presence information in the user management table 125 in association with the appropriate user.

Furthermore, the SIP server 100 has a roaming occasion detector 113, for detecting a roaming occasion in which a communication status between the call device 50 and the client terminal B is better than a communication status between the call device 50 and the client terminal A by a certain level or higher. The roaming occasion detector 113 detects the roaming occasion by referring to communication status data (e.g. radio intensity) between the call device 50 and each of the client terminals A and B, the data contained in the presence information related to each user in the user management table 125.

Moreover, the SIP server 100 has a roaming unit 114, which transmits a roaming instruction to the client server 300 assigned to the client terminal A, when the roaming occasion is detected. A roaming instruction is issued so that calls between the communication terminal 30 and the call device 50 can be established through the client terminal B instead of through the client terminal A.

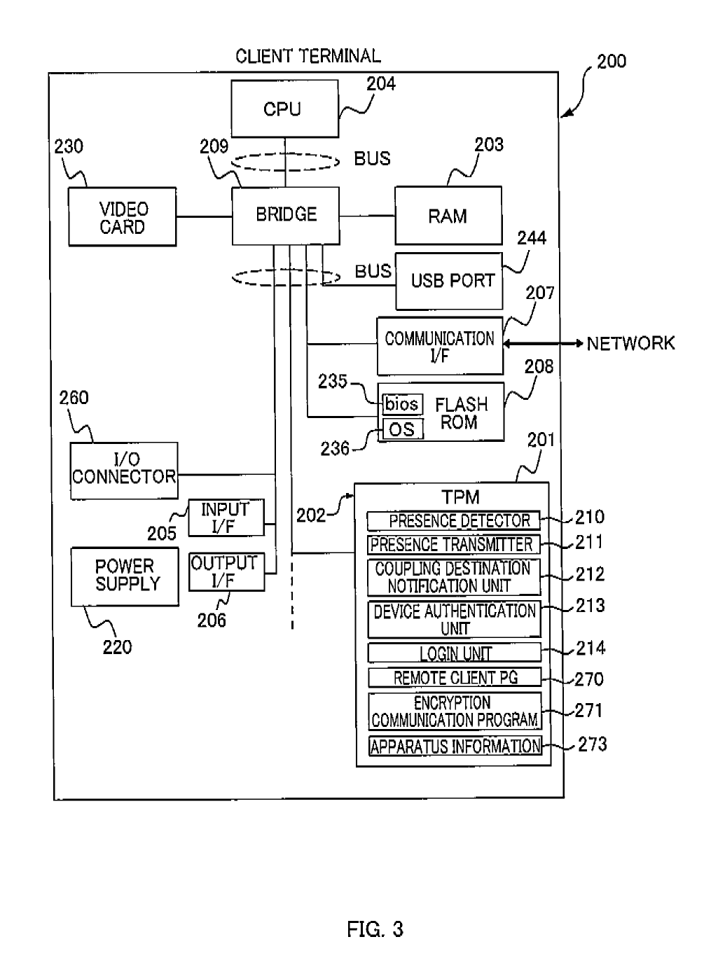

Next, a description will be given of the client terminal 200. FIG. 3 is a view showing a configuration example of the client terminal 200 of the embodiment. The client terminal 200 is an apparatus which accesses the client server 300 assigned by an appropriate management apparatus through the network 140, and controls the client server 300 remotely. The client terminal 200 constitutes a thin client system together with the client server 300. Additionally, the client terminal 200 loads, to a RAM 203, each of programs 202 stored in a TPM 201 and the like to implement a function of the present invention, and then executes the program 202 with a CPU 204 which is a processor.

Furthermore, the client terminal 200 has: input interfaces 205 such as various keyboards and buttons generally provided to a computer apparatus; an output interface 206 such as a display; and a communication interface 207 for exchanging data with apparatuses such as the SIP server 100, the client server 300 and the call device 50; and the like. If the call device 50 communicates with the client terminal 200 by short-range wireless communication, for example, the communication interface 207 is provided with a function of executing short-range wireless communication with the call device 50 (naturally, it does not matter whether a method for communicating with the call device 50 is wired or wireless.).

Such a client terminal 200 is a PC which does not include an HDD, and which is configured so that a printer, an external drive, an external memory and the like cannot be coupled locally nor be coupled through a network. In other words, the client terminal 200 is configured to be capable of using a printer, an external drive, an external memory and the like which are coupled to the client server 300 locally or are coupled through a network. Accordingly, the risk of information leakage due to theft of the client terminal 200 and the like is reduced.

Moreover, the client terminal 200 has: a USE port 244 for coupling various devices (the call device 50 may be included in the various devices), a flash ROM 208, I/O connectors 260 for coupling a keyboard and a mouse, a video card 230 for coupling a display, a bridge 209 for interconnecting buses which couple each of these units 201 to 260, and a power supply 220. After turning on the power supply 220, the CPU 204 first accesses the flash ROM 208 to execute a BIOS 235, thereby identifying a system configuration of the client terminal 200.

An OS 236 in the flash ROM 208 is a program for causing the CPU 204 to perform centralized control over the units 201 to 260 of the client terminal 200, and to execute programs corresponding to the function units to be described later. In accordance with the BIOS 235, the CPU 204 loads the OS 236 from the flash ROM 208 to the RAM 203 for execution. Note that a relatively small OS, such as an embedded OS storable in the flash ROM 208, is used as the OS 236 in the embodiment.

Next, a description will be given of function units configured and held by the client terminal 200 in the TPM 201 based on the programs 202, for example. The client terminal 200 has a presence detector 210 which detects the presence of the user in the following manner. Specifically, the presence detector 210 communicates with the call device 50 held by a user, acquires presence information including a user ID stored by the call device 50, and stores the information in the RAM 203.

In addition, the client terminal 200 has a presence transmitter 211 which reads the presence information of the user detected by the presence detection, and then generates another piece of presence information in which the former presence information includes the ID of the client terminal itself which has detected the presence. Subsequently, the presence transmitter 211 transmits the generated presence information to the SIP server 100.

Moreover, the client terminal 200 may have a coupling destination notification unit 212 which notifies the call device 50 held by the user detected by the presence detection, of coupling destination information. Here, notified is the coupling destination information of the client server 300 to which the client terminal 200 has been assigned.

Furthermore, assume a case where the call device 50 which is communicating with the communication terminal 30 by being coupled to the client terminal A travels, and as a result, becomes capable of being coupled to the client terminal B. Here, the presence detector 210 of the client terminal B acquires presence information including a user ID stored in the call device 50. Additionally, the presence transmitter 211 of the client terminal B transmits, to the SIP server 100, another piece of presence information in which the former presence information of the detected user includes an ID of the client terminal B itself, which has detected the presence.

Moreover, in terms of a login process in the thin client system, assume a case where a call device a of a user A has transmitted authentication information held in its own storage as an authentication request. The client terminal 200 has a device authentication unit 213 which, in this case, authenticates the device by checking the authentication information against authentication information held n its own storage 201 in response to the authentication request of the call device a. Then, the device authentication unit 213 returns the authentication result to the call device a.

In addition, the client terminal 200 has a login unit 214 which accepts input of a login request including user authentication information from the user A of the call device a at the input interface 205, and transmits a user authentication request including the user authentication information contained in the login request to the call device a. Then, the login unit 214 executes a login process related to the user and an initiation process of remote control over the client server 300, if the authentication result in accordance with the user authentication request made by the call device a is valid.

For example, when a call device b of a user B is coupled to the client terminal 200 to which the user A is currently logged in, in the above situation, the client terminal 200 secures a communication port for the call device b to communicate. Further, the presence detector 210 and the presence transmitter 211 similarly execute processes for the call device b.

Note that the client terminal 200 to which the user A is logged in may detect a logoff process by the user A from the client terminal 200. At this time, the client terminal 200 may recognize the call device b communicating with the communication terminal 30 through the client terminal 200, and may notify the call device b of a call termination notice.

Note that the client terminal 200 of the embodiment contains the function units 210 to 214, a remote client program 270, an encryption communication program 271, apparatus information 273, and the like in a chip called trusted platform module (TPM) 201.

The TPM 201 has a function similar to a security chip mounted in a smart card (an IC card), and is a hardware chip having a computing function with asymmetric keys and tamper resistance for securely storing these keys. Exemplary functions of the TPM 201 include: generation and storage of secret keys by the Rivest-Shamir-Adleman (RSA) scheme; computation (signature, encryption, and decryption) by RSA secret keys; a hash computation of the Secure Hash Algorithm 1 (SHA-1); storage of platform status information (a measured value of software) (PCR); storage of a reliability chain of keys, certificates, and credentials; generation of random numbers with high quality; nonvolatile memory; an Opt-in; an I/O; and the like.

The TPM has a function of securely storing the platform status information (a measured value of software) in Platform Configuration Registers (PCR) in the TPM 201 and of giving a notification, in addition to the functions of generation, storage, and operation of secret keys (asymmetric keys). Functions of locality, delegation (of authority), and the like are further added in the latest specification of the TPM 201. Incidentally, the TPM 201 is supposed to be attached physically to a part of a platform (such as a motherboard).

Additionally, the client terminal 200 of the embodiment has the remote client program 270 and the encryption communication program 271 in the TPM 201. The remote client program 270 is a program for causing the client terminal 200 to remotely access the desktop of the client server 300, and, for example, is a client (viewer) program of VNC. In accordance with the OS 236, the CPU 204 loads the remote client program 270 from the TPM 201 to the RAM 203, and executes the program. Consequently, the CPU 204 transmits input information of the I/o connector 260 (operation contents of a keyboard and a mouse) to the client server 300 through the network 140 such as VPN. Similarly, the CPU 204 outputs image information (desktop screen of a display) transmitted from the client server 300 through the network 140 such as VPN, to the output interface 206 such as a display coupled to the video card 230 and the like.

Furthermore, the encryption communication program 271 is a communication program for constructing a secure communication network such as VPN between itself and the client server 300 having an address notified by the remote client program 270. A communication program using IPsec may be assumed, for example. In accordance with the OS 236, the CPU 204 loads the encryption communication program 271 from the TPM 201 to the RAM 203, and executes the program. Accordingly, the CPU 204 transmits a communication initiation request to the client server 300 assigned to the client terminal 200 through the communication interface 207. The CPU 204 thus constructs a network such as VPN between itself and the appropriate client server 300, and performs remote control communication with the client server 300 through the VPN and the like.

In addition, the client terminal 200 of the embodiment has apparatus information 273 in the TPM 201. When transmitting a coupling establishment request and the like for remote control from the client terminal 200 to the client server 300, the apparatus information 273 refers to authentication information of the client terminal 200, which is included in the coupling establishment request and the like. Specifically, the apparatus information 273 can be assumed to be an ID, a model number, a MAC address and the like of the client terminal 200.

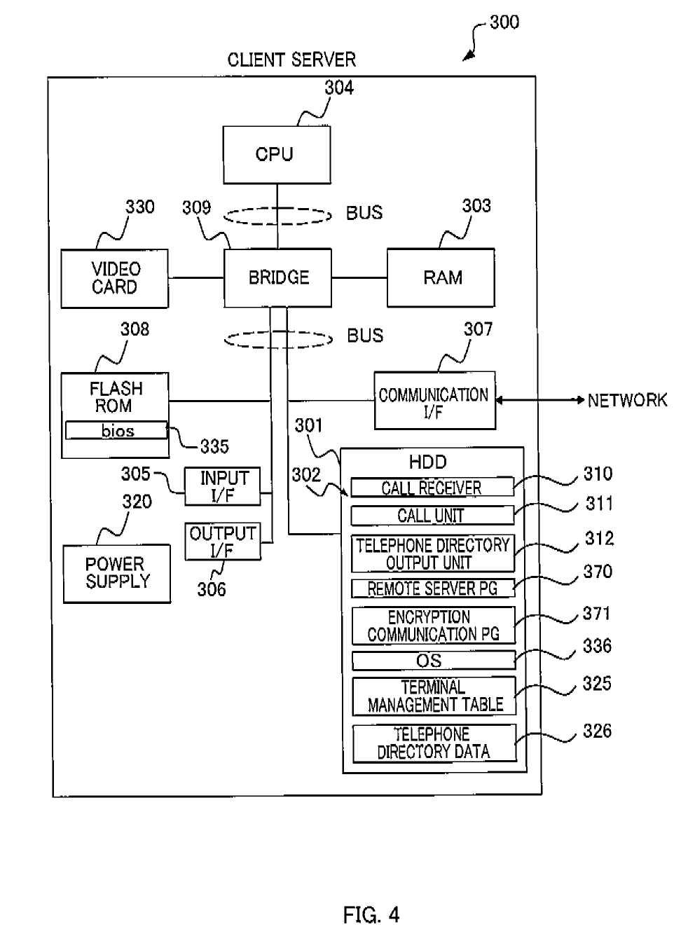

Next, a description will be given of the client server 300. FIG. 4 is a view showing a configuration example of the client server 300 of the embodiment. The client server 300 is a server apparatus constituting a thin client system by accepting remote access from the client terminal 200. Additionally, each of programs 302 stored in a hard disk drive (HDD) 301 and the like to implement a function of the present invention is loaded to a RAM 303 to be executed by a CPU 304 which is a processor.

Moreover, the client server 300 has: input interfaces 305 such as various keyboards and buttons which are generally provided to a computer apparatus; an output interface 306 such as a display if necessary; a communication interface 307 for exchanging data with apparatuses such as the SIP server 100 and the client terminal 200; and the like.

Furthermore, the client server 300 has a flash read only memory (ROM) 308, a video card 330 for generating the image information of a desktop, a bridge 309 relaying each of the units 301 to 330 and buses, and a power supply 320.

A basic input/output system (BIOS) 335 is stored in the flash ROM 308. After turning on the power supply 320, the CPU 304 firstly accesses the flash ROM 308 to execute the BIOS 335. Thus, the CPU 304 identifies the system configuration of the client server 300.

A description will be given of function units configured and held by such a client server 300, for example, based on the programs 302. Note that the client server 300 includes, in the storage 301, a terminal management table 325 which stores coupling destination information of the client terminal 200 assigned to the client server 300.

The client server 300 has a call receiver 310, which receives, from the SIP server 100, a call coupling request to request a call establishment process between the call device 50 coupled to the client terminal 200 assigned to itself and the communication terminal 30 originating a call to this call device 50. The call receiver 310 then causes an incoming call to be received at the call device 50 through the client terminal 200.

Additionally, the client server 300 has a call unit 311 which receives, through the client terminal 200, a call answer from the call device 50 which has answered the incoming call. Then, the call unit 311 notifies the communication terminal 30 of coupling destination information of the client terminal 200 read from the terminal management table 325 through the SIP server 100, and establishes a call between the call device 50 and the communication terminal 30.

Otherwise, the call unit 311 of the client server 300 may acquire a port number of the port coupling the call device 50 from the client terminal 200, and notify the communication terminal 30 of the port number and the coupling destination information of the client terminal 200 read from the terminal management table 325 through the SIP server 100. Thus, the call unit 311 may establish a call between the call device 50 and the communication terminal 30.

Moreover, the client server 300 remotely controlled by the client terminal 200 to which a user A is logged in may detect a logoff process by the user A from the client terminal 200. At this time, the client terminal 200 may recognize a call device b communicating with the communication terminal 30 through the client terminal 200, and may notify the call device b of a call termination notice.

In addition, the client server 300 may store, in the storage 301, telephone directory data 326 which is a coupling destination information list of a called party of the call device 50. In this case, the client server 300 may have a telephone directory output unit 312 which detects that the call device 50 has been coupled to the client terminal 200 coupled to itself. Then, the telephone directory output unit 312 reads the telephone directory data 326 from the storage 301, and outputs the data to the call device 50 through the client terminal 200.

Furthermore, the client server 300 stores a remote server program 370, an encryption communication program 371, and an operating system (OS) 336 in the HDD 301. The OS 336 is a program for causing the CPU 304 to perform centralized control over the units 301 to 330 of the client server 300, and to execute each program implementing each function unit such as the function unit 310. In accordance with the BIOS 335, the CPU 304 loads the OS 336 from the IDD 301 to the RAM 303 for execution. Thus, the CPU 304 performs centralized control over the units 301 to 330 of the client server 300.

Moreover, the remote server program 370 is a program for enabling remote control of the desktop of the client server 300 from the client terminal 200, and is a server program of virtual network computing (VNC) developed at AT&T Laboratories Cambridge, for example. In accordance with the OS 336, the CPU 304 loads the remote server program 370 from the HDD 301 to the RAM 303, and executes the program. Consequently, the CPU 304 receives and processes input information (operation contents of a keyboard and a mouse) transmitted from the client terminal 200 through the network 140 such as VPN. Similarly, the CPU 304 transmits image information (desktop screen of a display) showing the process result to the client terminal 200 through the network 140 such as VPN.

The encryption communication program 371 is a communication program for constructing the network 140 such as VPN between itself and the client terminal 200, and is a communication program using a security architecture for the internet protocol (IPsec), for example. In accordance with the OS 336, the CPU 304 loads the encryption communication program 371 from the HDD 301 to the RAM 303 for execution. Consequently, the CPU 304 constructs the secure network 140 such as VPN between itself and the client terminal 200, according to a coupling establishment request or the like for remote control, which has been received from the client terminal 200 through the communication interface 307. The CPU 304 thus performs remote control communication with the client terminal 200 through the VPN and the like.

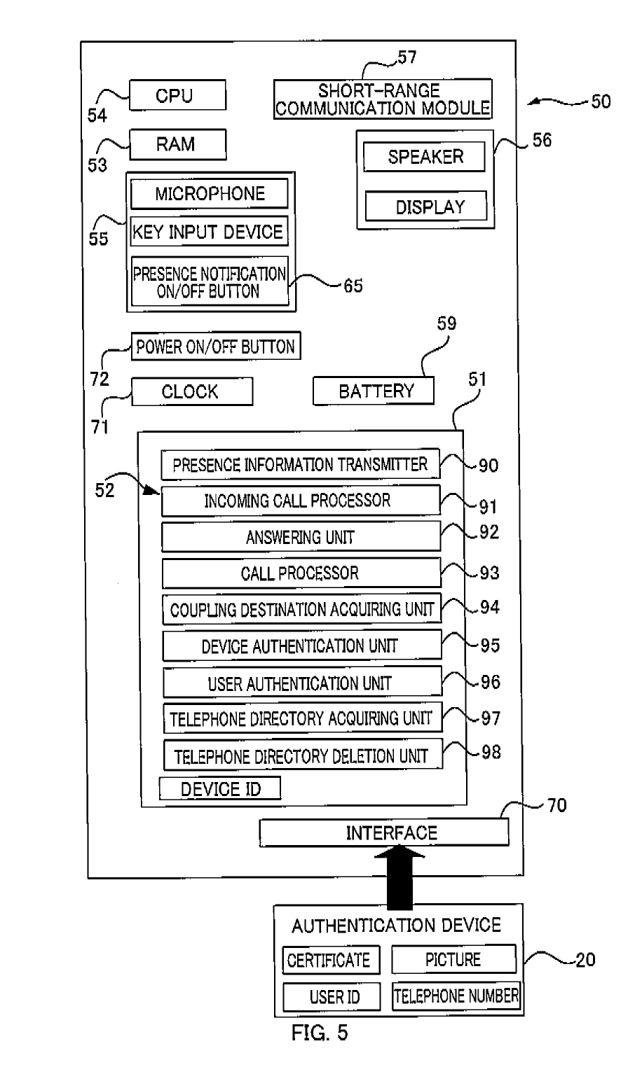

Next, a description will be given of the call device 50. FIG. 5 is a view showing a configuration example of the call device 50 of the embodiment. The call device 50 is a device which is coupled to the client terminal 200 and performs communication with a communication terminal originating a call to the SIP server 100. The call device 50 is assumed to be a device that can be easily carried by a user, for example, and has a CPU 54, a RAM 53, and a storage 51 storing programs 52. The call device 50 reads each of the programs 52 stored in the storage 51 (e.g. TPM and the like) to the RAM 53 to execute the program by the CPU 54 which is a processor.

Additionally, the call device 50 has: input interfaces 55 such as a microphone and various buttons represented by a ten-key and the like; output interfaces 56 such as a display and a speaker; and a communication interface 57 for exchanging data with the client terminal 200 (including exchange of data with the communication terminal 30 through the client terminal 200). If the call device 50 communicates with the client terminal 200 by short-range wireless communication, for example, the communication interface 57 is a module for short-range wireless communication.

Furthermore, the call device 50 has an interface 70 for coupling an authentication device 20, a power supply 59, a clock function 71, and a power button 72.

The authentication device 20 can be assumed to be an IC chip in which authentication information on a user of the call device 50 is stored. The authentication device 20 is assumed to be a subscriber identity module (SIM) card and the like which stores the IC chip in an appropriate storage case such as a plastic housing and which is coupled to the interface 70 of the call device 50 so that data communication can be performed. Examples of the authentication information include a unique ID for identifying the telephone number of a user, a digital certificate, face picture data of the user, and name information.

Note that basic functions of the call device 50 are assumed to be equivalent to an authentication device (trade name: KeyMobile) having the following configuration. Specifically, the authentication device is a memory card integrating an IC card portion into a flash memory, and in which a personal certificate, a secret key, and various kinds of application software necessary for mobile use are preinstalled.

A description will be given of function units configured and held by such a call device 50, for examples based on the programs 52. The call device 50 has a presence information transmitter 90 for transmitting, at the time of communication with the client terminal 200, a user ID stored in the storage 51 and the RAM 53 as presence information, to the client terminal 200. Note that a configuration may be employed in which the transmission of the presence information is controllable, that is, whether to transmit the presence information or not can be controlled by switching on/off a presence notification switch button 65 which is one type of the input interface 55 of the call device 50, for example. When the presence notification switch button 65 is turned “off”, for example, the presence information transmitter 90 stops transmitting the presence information. Meanwhile, when the presence notification switch button 65 is turned “on”, the presence information transmitter 90 transmits the presence information. By performing such processes, the transmission of presence information with unnecessary frequency under an unnecessary situation can be lessened, leading to overall improvement in process efficiency of the call management system 10.

Furthermore, the call device 50 has an incoming call processor 91 for outputting an incoming call notice to the certain output interface 56, in response to an incoming call process by the client server 300 received through the client terminal 200.

In addition, the call device 50 has an answering unit 92 for returning information on a call answer to the client terminal 200, under an instruction issued by the input interface 55 for a call answer in response to the incoming call.

Moreover, the call device 50 has a call processor 93 for executing the transmission/reception of call data to and from the communication terminal 30, if a call between the call device 50 and the communication terminal 30 which originated the call is established in response to the call answer.

Additionally, given that the client terminal 200 notifies the call device 50 of coupling destination information of the client server 300 assigned to the client server 200. In this case, the call device 50 (which has been detected by the client terminal 200 at this point) has a coupling destination acquiring unit 94, which receives the coupling destination information of the client server 300 transmitted from the client terminal 200, and stores the coupling destination information in the storage.

Moreover, the presence information transmitter 90 of the call device 50 may be configured to transmit presence information including the user ID and the coupling destination information of the client server 300 stored in the memory, when communicating with the client terminal 200 in the presence detection process of the client terminal 200.

Assume a case where a call device a of a user A communicates with the client terminal 200, and transmits authentication information stored in its own storage as an authentication request to the client terminal 200. Here, the call device a is assumed to have a device authentication unit 95 for establishing communication with the client terminal 200 in accordance with an authentication result. The authentication result is based on the authentication request, and is acquired from the client terminal 200.

Additionally, at this point, the client terminal 200 accepts a login request from the user A of the call device a, and the call device a receives, from the client terminal 200, the user authentication request containing the user authentication information included in the login request. The call device 50 being the call device a has a user authentication unit 96 which receives the user authentication request, and performs the following processes. Specifically, the user authentication unit 96 performs a user authentication process of checking authentication information included in the user authentication request against user authentication information stored in the storage, and a process of returning a result of the user authentication process to the client terminal 200.

Assume a case where the authentication result based on the user authentication request is valid, and the login process related to the user A and the initiation process of remote control over the client server 300 have been executed in the client terminal 200. Thereafter, a call device b of a user B is coupled to the client terminal 200 to which the user A is logged in. In this case, the call device b communicates by use of a communication port secured by the client terminal 200 for the call device b.

Note that the call device 50 has a telephone directory acquiring unit 97, which receives the telephone directory data 326 and stores the data in the RAM 53 when the telephone directory data 326 is transmitted from the client server 300 through the client terminal 200.

In addition, the call device 50 has a telephone directory deletion unit 98, which detects termination of a call between itself and the client terminal 200, and deletes the telephone directory data 326 in the RAM 53.

Note that each of the above-described function units 110 to 114, 210 to 214, 310 to 312, 90 to 98, and the like in the SIP server 100, the client terminal 200, the client server 300, and the call device 50 which constitute the call management system 10 may be implemented as hardware, or as programs stored in appropriate storages such as memory and a hard disk drive (HDD). In this case, CPUs of the respective apparatuses are caused to load appropriate programs from the storages to the respective memories in accordance with the execution of the program, and execute the programs.

Furthermore, as to the network 140, various networks such as an ATM circuit, a dedicated line, a wide area network (WAN), a PLC (Power Line Communication) circuit, a wireless network, a public network, and a mobile phone network in addition to the Internet and LAN may be used. Moreover, use of a virtual dedicated network technique such as a virtual private network (VPN) is suitable, since communication can be established with higher security when adopting the Internet.

Database Structure

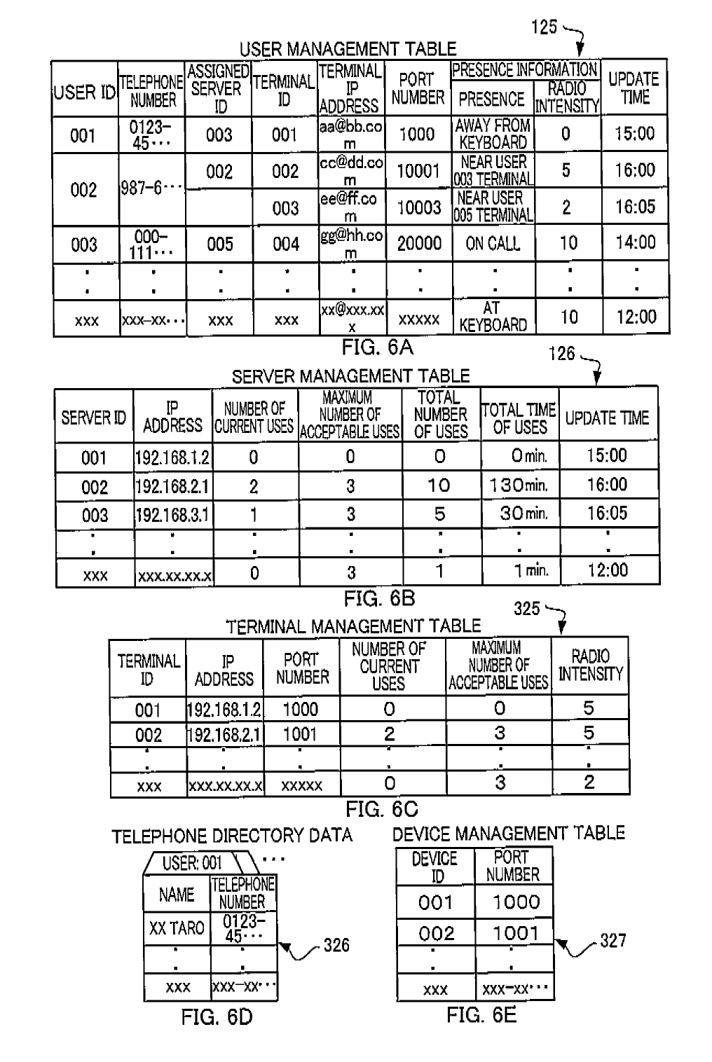

Next, a description will be given of the structures of various tables which may be used by each apparatus constituting the call management system 10 of the embodiment. FIG. 6A to 6E are views showing the examples of data structures of A; the user management table 125, B: a server management table 126, C; the terminal management table 325, D: the telephone directory data 326, and E; a device management table 327, respectively.

The user management table 125 is a table which is used by the SIP server 100, and which stores, for each user, the ID, the telephone number, the presence information, and information on an assigned client server in association with each other. The user management table 125 is an aggregate of records in which the following pieces of information are associated by taking a user ID (which is also an ID of a call device) as a key, for example. Examples of information registered in the user management table 125 include: the telephone number of a user; the ID of a client server assigned to the user; the ID and the IP address of a client terminal which is logged in; the port number in a client terminal to which a call device is coupled; the presence information (the location of a user, that is, a call device, and radio intensity between the call device and the client terminal); and update times of these pieces of information.

Note that the SIP server 100 also has the server management table 126 for managing the client server 300 within its management range. The server management table 126 is an aggregate of records in which the following pieces of information are associated with each other by taking the XD of the client server 300 as a key. Examples of the information registered in the server management table 126 include: the IP address of the client server; the number of current uses (the number of calls made by call devices at the client terminal under the client server); a maximum number of acceptable uses (a maximum number of call devices that can make calls at a client terminal under the client server); the total number of uses (the cumulative total of calls made by call devices at a client terminal under the client server); the total time of uses (the total time of calls made by call devices at a client terminal under the client server); and update times. The SIP server 100 can acquire an access destination by using this server management table 126 when communicating with the client server 300. Moreover, the SIP server 100 can check the business of the client server 300 (the client terminal under the client server 300).

Furthermore, the terminal management table 325 is a table which is used by the client server 300, and which stores the coupling destination information of the client terminal 200 assigned to the client server 300. The terminal management table 325 is an aggregate of records in which the following pieces of information are associated with each other by taking the terminal ID of the client terminal 200 as a key, for example. Examples of the information registered in the terminal management table 325 include: an IP address; a port number; the number of current uses (the number of call devices making a call by accessing to the client terminal); a maximum number of acceptable uses (a maximum number of call devices that can make a call by being coupled to the client terminal); and radio intensity (actual radio intensity when the client terminal is coupled to the call device in short-range wireless communication). Naturally, the SIP server 100 may also be provided with the terminal management table 325.

Additionally, the telephone directory data 326 is used by the client server, and is the coupling destination information list of a called party of the call device 50. For example, the telephone directory data 326 is generated and managed for each user, that is, for each call device 50, and is an aggregate of telephone numbers which are coupling destination information on called parties.

Moreover, the device management table 327 is used by the client terminal 200, and stores the device XD of the call device 50 which is detected while being located near the client terminal 200, and a port number associated to make a call to the call device 50.

First Exemplary Process Flow

A description will hereinafter be given of an actual procedure of the call management method of the embodiment based on the drawing. Note that various operations corresponding to the call management method to be described later are implemented by programs of the SIP server 100, the client terminal 200, the client server 300, the call device 50, and the communication terminal 30, which constitute the call management system 10. Each of the programs is loaded to the RAM and the like for execution. Each program is configured of codes for carrying out various operations to be described later.

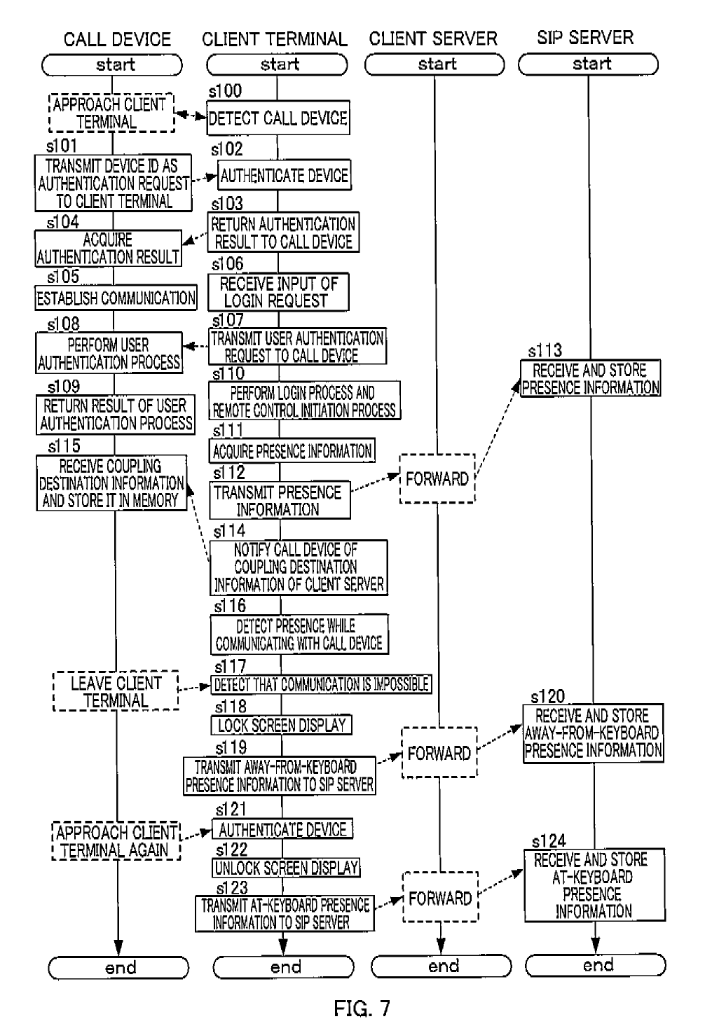

FIG. 7 is a view showing a first exemplary process flow of the call management method of the embodiment. The description will first be given of a main flow of the call management method of the embodiment. Note that in the call management method of the embodiment, the aforementioned technique disclosed in Document 1 may be adopted as a base for a basic procedure related to control over a call between the communication terminal 30 and the call device 50. Hence, the description of the basic technique, which is disclosed in Document 1, will be omitted below.

As a given situation, each user is assumed to carry the call device 50 as a personal authentication tool in an office, for example. In addition, a thin client system is adopted in the office, and each of the users is provided with, and uses a client terminal 200 in which a hard disk is omitted. Moreover, the client terminal 200 performs remote desktop coupling with the client server 300 through a network, and uses, through the network, various application programs and data provided to the client server 300. Furthermore, the SIP server 100 is coupled to the thin client system. The SIP server 100 accepts, as a telephony server corresponding to a protocol of SIP, a call originated by the communication terminal 30 or the client terminal 200.

Under this situation, the user approaches the client terminal 200 carrying the call device 50, in order to log in to his/her own client terminal 200. Here, assume that the call device 50 and the client terminal 200 are each provided with an interface for short-range wireless communication used for coupling between apparatuses with a distance of approximately several meters, such as Bluetooth®, as a communication interface. In this case, the user is not required to take the trouble of coupling the call device 50 directly with the client terminal 200 whenever the user logs in to the client terminal 200, or makes a call through the client terminal 200. In other words, the user is only required to carry the call device 50.

For example, the wireless communication interface 207 of the client terminal 200 performs a sensing operation on its surroundings at predetermined timings, in order to detect the presence of call devices. Here, suppose that the user approaches the client terminal 200 with a call device 50. At this point, the client terminal 200 detects the call device 50 (s100), and starts communicating with the call device 50. The device authentication unit 95 of the call device 50 then transmits authentication information (e.g. a device ID) provided in its own storage, as an authentication request to the client terminal 200 (s101).

Meanwhile, upon receipt of the authentication request from the call device 50, the device authentication unit 213 of the client terminal 200 performs device authentication by checking the authentication information against authentication information (e.g. an ID list of the call devices 50 assigned to itself) provided in its own storage (s102). The device authentication unit 213 then returns the authentication result to the call device 50 (s103).

The device authentication unit 95 of the call device 50 acquires the authentication result based on the authentication request, which has been returned by the client terminal 200 (s104). The device authentication unit 95 then establishes communication between itself and the client terminal 200 if the authentication result indicates “authentication OK” (s105). For example, at this point, the call device 50 and the client terminal 200 display “device authentication OK” and the like on an output interface.

Then, the user having recognized that the device authentication has been processed successfully inputs user authentication information such as his/her user ID or password through the input interfaces 205 such as a keyboard and the like of the client terminal 200, in order to log in to the client terminal 200. At this point, the login unit 214 of the client terminal 200 accepts input of a login request from the user at the input interfaces 205 (s106), the login request including the user authentication information. Then, the login unit 214 transmits a user authentication request including the user authentication information contained in the login request to the call device 50 (s107).

The user authentication unit 96 of the call device 50 receives the user authentication request, and performs a user authentication process by checking the authentication information included in the user authentication request against user authentication information stored in (the authentication device 20 of) a storage (s108). The user authentication unit 96 then returns the result of the user authentication process to the client terminal 200 (s109).

Meanwhile, the login unit 214 of the client terminal 200 receives the authentication result based on the user authentication request from the call device 50. If the authentication result is valid, the login unit 214 executes the login process related to the user and the initiation process of remote control over the client server 300 (s110). Thus, the device authentication process and the user authentication process are performed by use of the call device 50, so that the user can use the client server 300 by remote desktop coupling through the client terminal 200.

On the other hand, the call device 50, the client terminal 200 and the like have original functions unique to the present invention, in addition to their conventional roles in the device authentication and the login process. Here, the presence detector 210 of the client terminal 200 acquires presence information (e.g. a user ID, a device ID, and the telephone number of a call device) including a user ID stored in the call device 50 carried by the user, by communicating with the call device 50 (s111). At this point, the client terminal 200 detects the presence of the call device 50 (the presence of the user carrying the device).

Next, the presence transmitter 211 of the client terminal 200 transmits, to the SIP server 100, another piece of presence information (e.g. a user ID, a device ID, the telephone number of a call device, the ID and the IP address of the client terminal, time information, a port number of the client terminal to which a call device is coupled, radio intensity, the login status of the user). This other piece of presence information includes the TD of the client terminal 200 itself which has detected the presence, in addition to the former presence information of the user which has been detected by the presence detection (s112).

At this point, the presence acquiring unit 110 of the SIP server 100 receives the presence information transmitted from the client terminal 200, and stores the presence information in the user management table 125 in association with the user (s113).

Note that the coupling destination notification unit 212 of the client terminal 200 notifies the call device 50 held by the user detected by the presence detection of coupling destination information of the client server 300 to which the client server 200 is assigned (s114).

Meanwhile, the coupling destination acquiring unit 94 of the call device 50 receives the coupling destination information of the client server 300 transmitted from the client terminal 200, and stores the information in the storage (s114). Thereafter, the presence information transmitter 90 of the call device 50 transmits presence information including the user XD and the coupling destination information of the client server 300 stored in the storage, when communicating with the client terminal 200 in the presence detection process of the client terminal 200.

Note that the client terminal 200 continuously detects the presence of the call device 50 by communicating with the call device 50 (s116). However, if the user leaves the keyboard of the client terminal 200 and carries the call device 50, the communication between the client terminal 200 and the call device 50 is interrupted from the moment the user steps out of the communicable area of the wireless communication interface. Accordingly, the client terminal 200 detects this timing at which communication is disabled (s117), and locks a screen display on a display apparatus serving as the output interface 106, for example (s118). Additionally, the client terminal 200 transmits presence information (the user ID, the radio intensity, the status of being away from the keyboard) containing the fact that the user has left the keyboard, to the SIP server 100 through the client server 300 (s119).

At this point, the presence acquiring unit 110 of the SIP server 100 receives the presence information indicating that the user is away from the keyboard, the information being transmitted from the client terminal 200, and stores the information in the user management table 125 in association with the appropriate user (s120). Such presence information is similarly transmitted to the SIP server 100 from other client terminals 200 when the user approaches the other client terminals 200. Accordingly, the SIP server 100 can always be aware of the presence of each user.

Note that when the user who had been away from the keyboard returns to the client terminal 200, the client terminal 200 performs the device authentication process (s121), then unlocks the screen display on the display apparatus (s122). Moreover, the client terminal 200 transmits presence information (the user ID, the radio intensity, the status of being at the keyboard) indicating that the user has returned to the keyboard, to the SIP server 100 through the client server 300 (s123). The SIP server 100 receives the presence information indicating that the user is at the keyboard, and stores the information in the user management table 125 in association with the user (s124).

Second Exemplary Process Flow

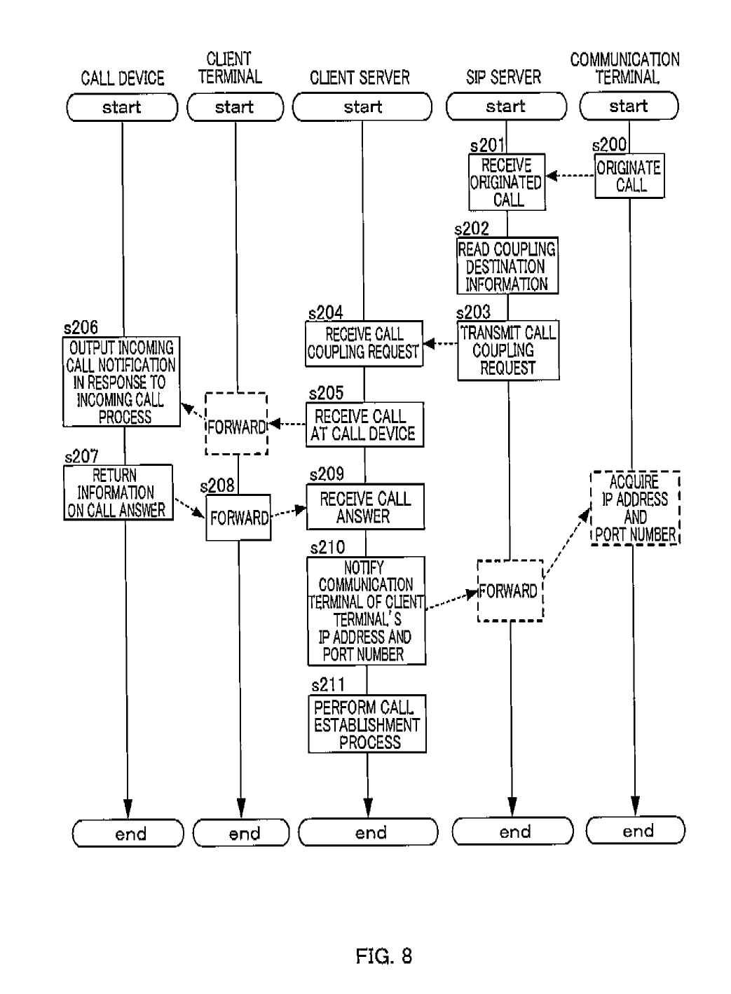

A description has been given of the procedure for managing the presence of a user, that is, the presence of the call device 50 in the above first exemplary process flow. Next, a description will be given of a procedure for managing a call between the call device 50 and the communication terminal 30 by use of such a presence management method. FIG. 8 is a view showing a second exemplary process flow of the information process method of the embodiment.

First of all in this flow, assume that a telephone terminal (hereinafter referred to as the telephone terminal 30) serving as the communication terminal 30 originates a call by designating the telephone number of a desired call destination (s200). The coupling destination reader 111 of the SIP server 100 accepts this (s201), and reads, as coupling destination information, presence information on a user corresponding to the telephone number of the call destination of the originated call and the information on the assigned client server 300, from the user management table 125 (s202).

Furthermore, the coupling request unit 112 of the SIP server 100 transmits a call coupling request to the assigned client server 300 designated by the coupling destination information (s203). The call coupling request includes coupling information (e.g. the IP address of the telephone terminal) of the telephone terminal 30 included in the originated call, and is issued to request call establishment between the telephone terminal 30 and the call device 50 held by the user coupled to the client terminal 200 indicated by the presence information of the coupling destination information.

At this point, the call receiver 310 of the client server 300 receives the call coupling request transmitted from the SIP server 100 (s204), and executes an incoming call to be received at the call device 50 through the client terminal 200 (s205).

Meanwhile, the incoming call processor 91 of the call device 50 accepts an incoming call process performed by the client server 300 through the client terminal 200, and outputs a predetermined incoming call notification such as a ring tone output and a flashing LED by the output interface 56 (s206).

Assume that a user of the call device 50 recognizes the incoming call notification output and answers it. At this point, the answering unit 92 of the call device 50 receives, from the input interface 55, a user instruction (such as pressing a call button) to answer the call in response to the incoming call, and returns the information on the call answer to the client terminal 200 (s207).

In addition, the client terminal 200 forwards the call answer information to the client server 300 (s208). The call unit 311 of the client server 300 then receives the call answer information from the call device 50 in response to the incoming call, through the client terminal 200 (s209). Moreover, the call unit 311 acquires a port number corresponding to the call device 50 from the client terminal 200. Then, the call unit 311 notifies, through the SIP server 100, the telephone terminal 30 of the port number and the coupling destination information (the IP address) of the client terminal 200 read from the terminal management table 325 (s210). Thus, the call unit 311 establishes a call between the call device 50 and the telephone terminal 30 (s211).

On the other hand, if the call is established between itself and the telephone terminal 30 which originated the incoming call by answering the call, the call processor 93 of the call device 50 executes the transmission and reception of the call data to and from the telephone terminal 30.

Hereinabove, a description has been given of a call originated by the telephone terminal 30, serving as a communication terminal, toward the call device 50. However, a call originated by the call device 50 toward the telephone terminal 30 may also be assumed. In this case, the originated call includes a datum on the telephone number of the telephone terminal 30. The client server 300 transmits, as coupling destination information of the call device 50 which is originating the call, the IP address of the client terminal 200 to which the call device 50 is coupled and a port number corresponding to the call device 50, to the SIP server 100. The SIP server 100 then transmits a call coupling request (including the coupling destination information of the call device 50) for coupling with the telephone terminal 30, by use of the telephone number. If the call is answered at the telephone terminal 30, the client terminal 200 performs the call establishment process between the telephone terminal 30 and the call device 50 in the same manner as described above.

Third Exemplary Process Flow

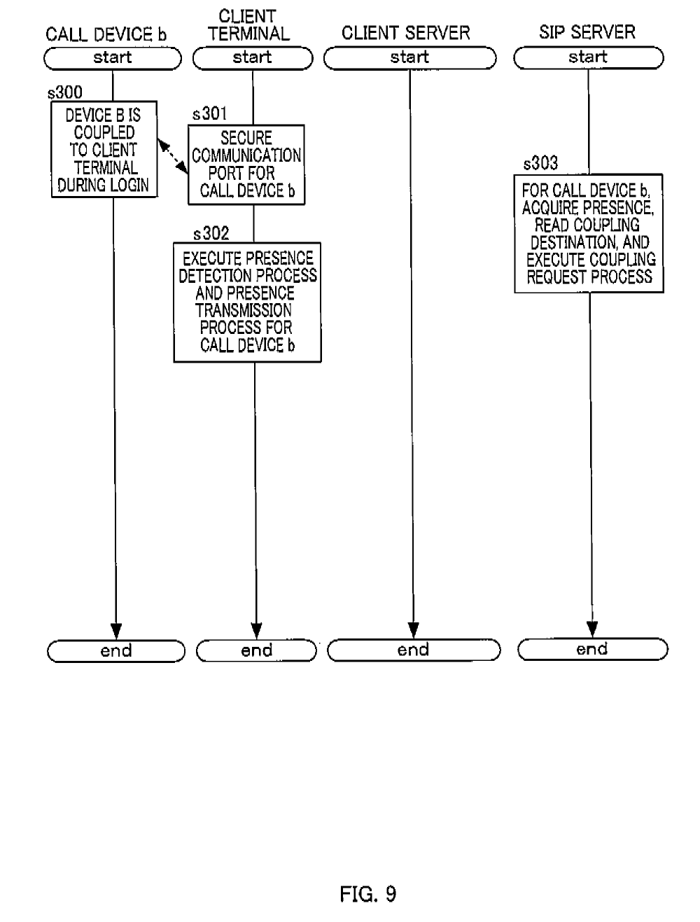

Next, assumed is a situation in which a user B approaches the client terminal 200 to which another user A is logged in with a call device a, and the user B makes a call with the call device b. FIG. 9 is a view showing a third exemplary process flow of the information process method of the embodiment. In this case, as shown in the above first exemplary process flow, it is assumed that user authentication and device authentication have been performed successfully on the user A and the call device a, respectively, and the login process related to the user A and the initiation process of remote control over the client server 300 have already been executed by the client terminal 200.

Thus, even under a situation where a user is logging in to his/her client terminal 200, the client terminal 200 allows a call port to be used by another user and allows a call to be made by use of the client terminal 200 (that is, a terminal which is not a client terminal for another user). Naturally, only resources for calling (e.g. a dedicated communication port for another user, and a communication module for an external apparatus) are opened to other users, and resources which should originally be used by a user with security are not opened to others, as should be in a normal thin client system.

In the embodiment under such situations, assume that the call device b of the user B approaches the client terminal 200 to which the user A is logged in, and is coupled to the client terminal 200 (s300). In this case, the client terminal 200 secures a communication port for the call device b (s301), to communicate with the communication device b. In addition, the presence detector 210 and the presence transmitter 211 of the client terminal 200 execute the presence detection process and the presence transmission process for the call device b (s302). Meanwhile, the SIP server 100 executes each process for the call device b at the presence acquiring unit 110, the coupling destination reader 111, and the coupling request unit 112 (s303). Afterwards, the client terminal 200 performs the process of establishing a call between the call device b and the communication terminal 30.

Fourth Exemplary Process Flow

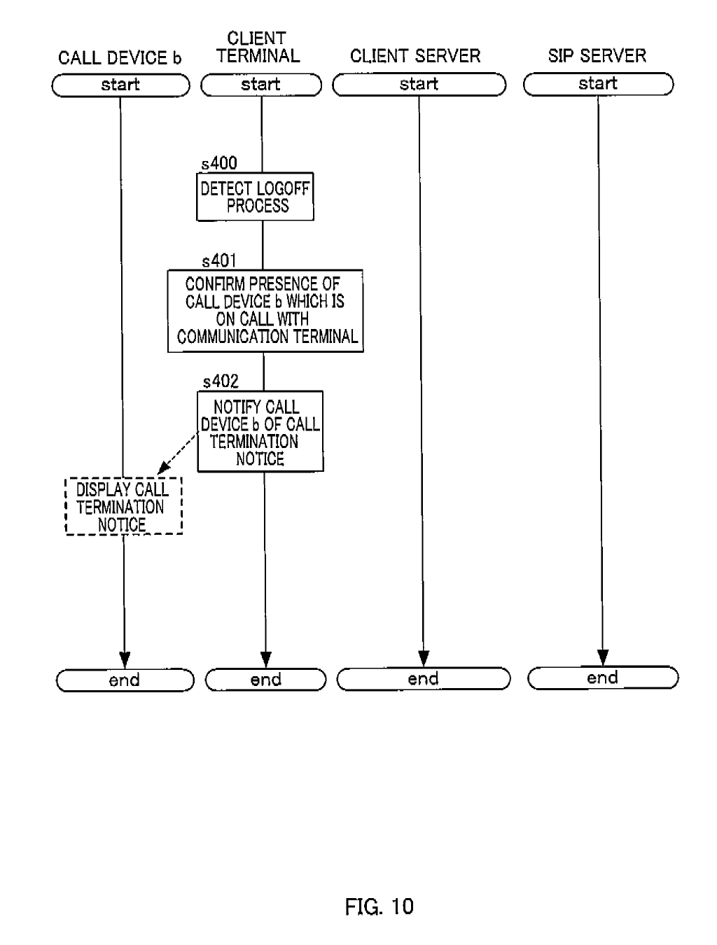

FIG. 10 is a view showing a fourth exemplary process flow of the information process method of the embodiment. As has been described above, in this embodiment, it is possible to assume the following situation. Specifically, a user is originally logged in to the client terminal 200 and uses the terminal, and then the call device 50 of another user comes to be coupled to the client terminal 200 in order to communicate with the communication terminal 30.

For example, the client terminal 200 to which the user A is currently logged in detects a logoff process of the user A from the client terminal 200 (s400). As this detection, the logoff operation may be detected at the input interface 205. At this point, the client terminal 200 confirms the presence of the call device b on a call with the communication terminal 30 through the client terminal 200 (s401). As this confirmation process, the terminal management table 325 of the assigned client server 300 may be read to confirm whether the call device of a user other than the user A is coupled to the client terminal 200.

The client terminal 200 which has confirmed the existence of the call device b notifies the call device b of a call termination notice (s402). Notifying the call device b of the call termination notice makes it easier to avoid, in advance, a situation where the line is suddenly broken while the user B of the call device b is calling. On recognizing the call termination notice, the user B may temporarily cut off the call, approach to be coupled with another client terminal 200, and make another call with the communication terminal 30 with the same telephone number.

Note that although the client terminal 200 executes the fourth exemplary process flow in the above description, the client server 300 remotely controlled by the client terminal 200 may otherwise execute the fourth exemplary process flow.

Fifth Exemplary Process Flow

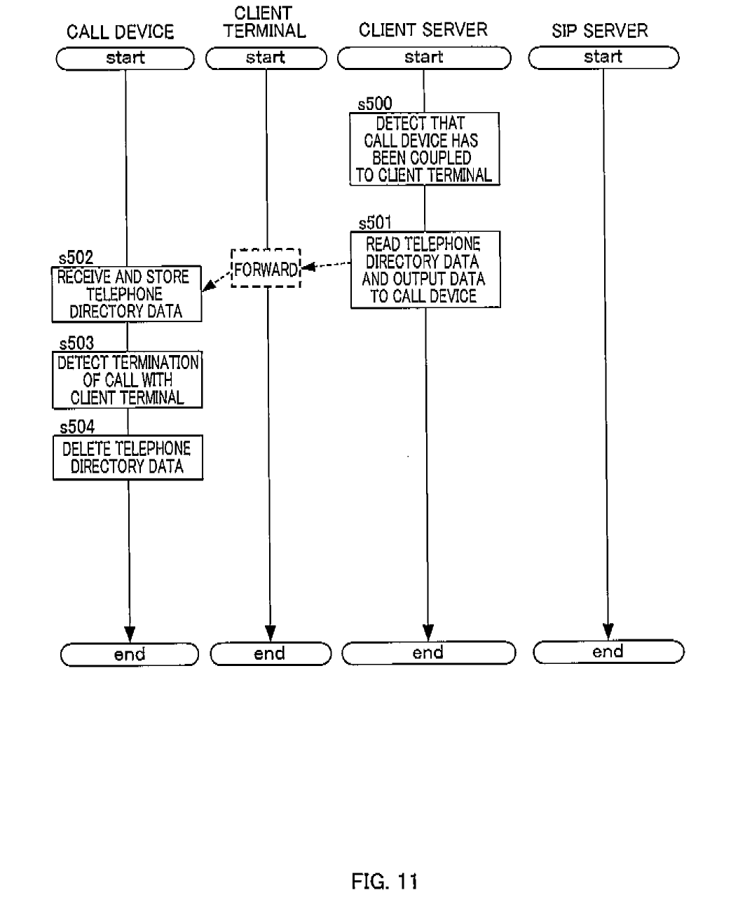

FIG. 11 is a view showing a fifth exemplary process flow of the information process method of the embodiment. Next, a description will be given of the telephone directory data used by the call device 50. Here, the client server 300 is assumed to store the telephone directory data 326 in the storage.

At this point, the telephone directory output unit 312 of the client server 300 detects that the call device 50 has been coupled to the client terminal 200 which is coupled to itself, based on presence information, for example (s500). The telephone directory output unit 312 then reads the telephone directory data 326 from the storage, and outputs the data to the call device 50 through the client terminal 200 (s501).

Meanwhile, the telephone directory acquiring unit 97 of the call device 50 receives the telephone directory data 326 transmitted from the client server 300 through the client terminal 200, and stores the data in the RAM 53 (s502). The telephone directory data 326 thus acquired is displayed on a display (the output interface 56) under a user's instruction through the input interface 55, and is used in various ways such as originating a call and displaying an incoming call.

Afterwards, the telephone directory deletion unit 98 of the call device 50 detects that the coupling of the client terminal 200 is terminated (s503), and deletes the telephone directory data 326 in the RAM 53 (s504). By performing such a process, concerns about information leakage can be reduced even if the call device 50 is stolen or the like, since the telephone directory data 326 is not left in the call device 50.

Sixth Exemplary Process Flow

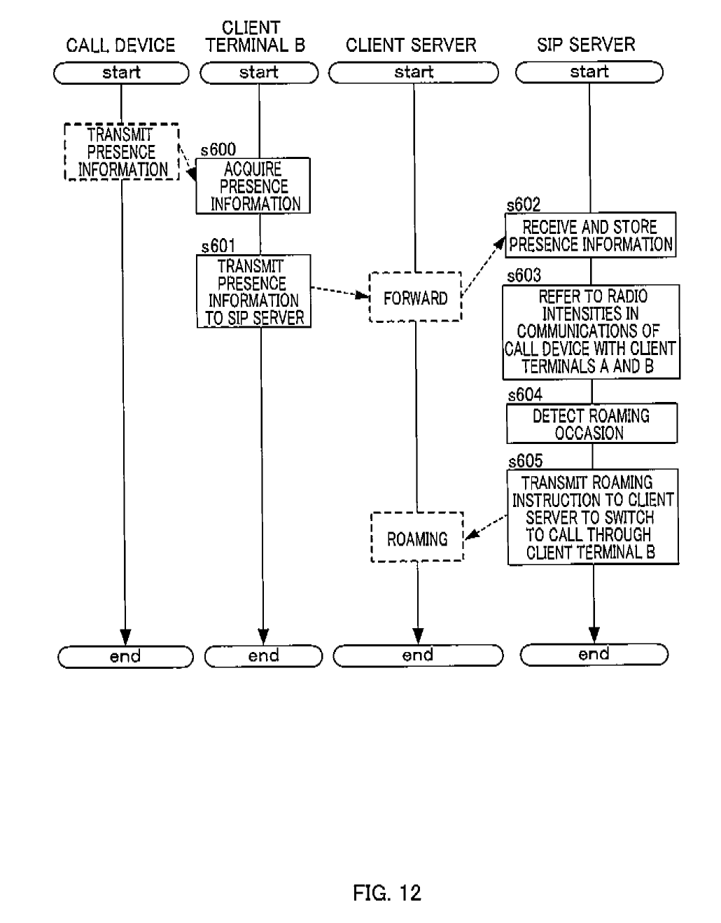

FIG. 12 is a view showing a sixth exemplary process flow of the information process method of the embodiment. When a call between the call device 50 and the communication terminal 30 is established, the communication data therebetween is generally exchanged in P-to-P. However, a situation may be assumed as an example where the client server 300 exchanges the call data between the call device 50, coupled to the client terminal 200, and the communication terminal 30. For example, the communication terminal 30 transmits call packets to the IP address of the client server 300, and then the client server 300 separates the call packets for each destination call device before forwarding them to the client terminal 200.

At this point, assume that the call device 50 which had been communicating with the communication terminal 30 by being coupled to a client terminal A travels, and as a result, becomes capable of being coupled to another client terminal B. In this case, the presence detector 210 of the client terminal B acquires presence information including a user ID stored in the call device 50 (s600). The presence transmitter 211 of the client terminal B transmits, to the SIP server 100, another piece of presence information in which the ID of the client terminal B itself which has detected the presence is included in the former presence information of the detected user (s601).

Meanwhile, the presence acquiring unit 110 of the SIP server 100 receives the presence information transmitted from the client terminal B, and stores the information in the user management table 125 in association with the user (s602).

Furthermore, the roaming occasion detector 113 of the SIP server 100 refers to each piece of communication status data (e.g. radio intensity) between the call device 50 and the client terminals A and B, included in each piece of presence information related to the user in the user management table 125 (s603).

Then, the roaming occasion detector 113 detects a roaming occasion in which a communication status between the call device 50 and the client terminal B is better than a communication status between the call device 50 and the client terminal A by a specified level or higher (s604). For example, assume that a roaming occasion from the client terminal A to the client terminal B arises when the difference in radio intensities between the call device 50 and the client terminals A and B differ by 3 or more. In this case, if the radio intensity between the call device 50 and the client terminal A is “1”, whereas the radio intensity between the call device 50 and the client terminal B is “5”, the roaming occasion detector 113 perceives that a roaming occasion from the client terminal A to the client terminal B has risen.

Moreover, when the roaming occasion is detected, the roaming unit 114 of the SIP server 100 transmits a roaming instruction to the client server 300 assigned to the client terminal A, so that calls between the communication terminal 30 and the call device 50 can be established through the client terminal B, instead of through the client terminal A (s605). After receiving the roaming instruction, the client server 300 transmits call packets related to the call device 50 from a port secured for the client terminal B.

By performing roaming in this manner, a handover process can be performed smoothly without cutoffs of the communication line and the like. This is because the IP address of the client server to which call packets should be transmitted from the communication terminal 30 does not have to be changed.

The present invention enables call management in accordance with the presence of a user in a thin client system.

Hereinabove, specific descriptions of an embodiment of the present invention have been given on the basis of the embodiment. However, the present invention is not limited to the embodiment, and various modifications can be applied without departing from the spirit and scope of the invention.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A call management system comprising:
a client server;
a client terminal which remotely controls the client server; and
a management server which manages communication between a call device coupled to the client terminal and a communication terminal, the client server and the client terminal constituting a thin client system, wherein
the client terminal executes:
a presence detection process of detecting the presence of a user by communicating with the call device held by the user and by acquiring presence information including a user XD stored in the call device; and
a presence transmission process of transmitting, to the management server, presence information including the presence information of the user detected by the presence detection, and also including the ID of the client terminal itself which has detected the presence,
the management server including a user management table which stores an ID, a phone number and presence information of each user as well as information on the assigned client server in association with each other, executes:
a presence acquiring process of receiving the presence information transmitted from the client terminal, and storing the presence information in the user management table in association with an appropriate user;
a coupling destination reading process of, upon receipt of a call originated by the communication terminal, reading presence information of a user corresponding to a phone number of a call destination of the originated call and information on the assigned client server, from the user management table as coupling destination information; and
a coupling request process of transmitting, to the assigned client server designated by the coupling destination information, a call coupling request which includes coupling information of the communication terminal included in the originated call, and which requests establishment of a call between the communication terminal and the call device held by the user and coupled to the client terminal indicated by the presence information of the coupling destination information.

2. The call management system according to claim 1, wherein
the client server includes a terminal management table storing the coupling destination information of an assigned client terminal, and
the client server executes:
an incoming call process of receiving the call coupling request transmitted from the management server and causing the call device to receive a call through the client terminal; and
a call process of, upon receipt of a call answer from the call device in response to the incoming call through the client terminal, notifying the communication terminal of the coupling destination information of the client terminal read from the terminal management table through the management server, and establishing a call between the call device and the communication terminal.

3. The call management system according to claim 1, wherein in the call process, the client server acquires a port number corresponding to the call device from the client terminal, notifies the communication terminal of the coupling destination information of the client terminal read from the terminal management table and the port number through the management server, and establishes a call between the call device and the communication terminal.

4. The call management system according to claim 1, wherein
the client terminal executes a coupling destination notification process of notifying the call device held by the user detected by the presence detection, of the coupling destination information of the client server to which the client terminal is assigned,
the call device executes a coupling destination acquiring process of receiving the coupling destination information of the client server transmitted from the client terminal, and storing the information in a storage, and
when communicating with the client terminal in the presence detection process, the call device transmits the presence information including the user ID and the coupling destination information of the client server which is stored in the storage.

5. The call management system according to claim 1, wherein:
the client server exchanges call data between the communication terminal and the call device coupled to the client terminal, and
when the call device communicating with the communication terminal while being coupled to a client terminal A travels, and as a result, becomes capable of being coupled to a client terminal B,
the client terminal B
executes the presence detection process to acquire the presence information including the user XD stored in the call device, and
executes the presence transmission process to transmit, to the management server, presence information including the presence information of the detected user, and also including the ID of the client terminal B itself which has detected the presence; and
the management server executes:
a roaming occasion detection process of executing the presence acquiring process to receive the presence information transmitted from the client terminal B, storing the presence information in the user management table in association with an appropriate user, referring to communication status data between the call device and the client terminals A and B, which is included in each piece of the presence information of the user in the user management table, and detecting a roaming occasion in which a communication status between the call device and the client terminal B is better than a communication status between the call device and the client terminal A by a specified level or higher; and
a roaming process of, when the roaming occasion is detected, transmitting a roaming instruction to the client server assigned to the client terminal A, so that calls between the communication terminal and the call device is established through the client terminal B instead of through the client terminal A.

6. The call management system according to claim 1, wherein
a call device a of a user A communicates with the client terminal, transmits authentication information provided in its own storage to the client terminal as an authentication request, and executes a process of establishing a call with the client terminal according to an authentication result based on the authentication request acquired from the client terminal,
upon receipt of the authentication request from the call device a, the client terminal executes a device authentication process of checking the authentication information against the authentication information provided in its own storage, and returning the authentication result to the call device a, and
the client terminal receives a login request including user authentication information from the user A of the call device a through an input interface, transmits a user authentication request including the user authentication information contained in the login request to the call device a, and executes a login process for the user and an initiation process of remote control over a client server, when the authentication result based on the user authentication request made by the call device a is valid, and
when a call device b of a user B is coupled to the client terminal to which the user A in logged in,
the client terminal secures a communication port for the call device b to communicate, and executes the presence detection process and the presence transmission process for the call device b, and
the management server executes the presence acquiring process, the coupling destination reading process, and the coupling request process for the call device b.

7. The call management system according to claim 6, wherein the client terminal to which the user A is logged in or the client server which is remotely controlled by the client terminal detects a logoff process of the user A from the client terminal, then, upon this detection, confirms the call device b on a call with the communication terminal through the client terminal, and notifies the call device b of a call termination notice.

8. The call management system according to claim 1, wherein;
the client server
stores, in a storage, telephone directory data which is a coupling destination information list of a called party of the call device, and
executes a telephone directory output process of detecting that a call device is coupled to the client terminal coupled to the client server itself, reading the telephone directory data from the storage, and outputting the data to the call device through the client terminal; and
the call device executes
a telephone directory acquiring process of receiving the telephone directory data transmitted from the client server through the client terminal and storing the data in a storage, and
a telephone directory deletion process of detecting that communication with the client terminal is terminated, and deleting the telephone directory data in the storage.

9. A call management method for a thin client system including a client server, a client terminal which remotely controls the client server, a management server which manages communication between a call device coupled to the client terminal and a communication terminal,
the method comprising
the client terminal executing:
a presence detection process of detecting the presence of a user by communicating with a call device held by a user, and by acquiring presence information including a user ID stored in the call device, and
a presence transmission process of transmitting, to a management server, presence information including the presence information of the user detected by the presence detection, and also including the ID of the client terminal itself which has detected the presence;
the management server including a user management table for storing an ID, a phone number and presence information of each user as well as information on the assigned client server in association with each other, executing:
a presence acquiring process of receiving the presence information transmitted from the client terminal, and storing the presence information in the user management table in association with an appropriate user;
a coupling destination reading process of, upon receipt of a call originated by the communication terminal, reading the presence information of a user corresponding to a phone number of a call destination of the originated call and information on the assigned client server, from the user management table as coupling destination information; and
a coupling request process of transmitting, to the assigned client server designated by the coupling destination information, a call coupling request which includes coupling information of the communication terminal included in the originated call, and which requests establishment of a call between the communication terminal and the call device held by the user and coupled to the client terminal indicated by the presence information of the coupling destination information.

10. A management server communicating with a client server in a thin client system, and managing calls between a communication terminal and a call device coupled to a client terminal which remotely controls the client server, the management server comprising:
a communication interface for communicating with the client server and the communication terminal;
a storage storing a user management table which stores an ID, a telephone number, and presence information of each user as well as information on the assigned client server in association with each other; and
a processor executing
a presence acquiring process of receiving, from the client terminal, presence information including a user ID that the client terminal has acquired from the call device coupled to itself and the ID of the client terminal itself, and storing the information in the user management table in association with an appropriate user;
a coupling destination reading process of, upon receipt of a call originated by the communication terminal, reading presence information of a user corresponding to a telephone number of a call destination of the originated call and information on the assigned client server, from the user management table as coupling destination information; and
a coupling request process of transmitting, to the assigned client server designated by the coupling destination information, a call coupling request which includes coupling information of the communication terminal included in the originated call, and which requests establishment of a call between the communication terminal and the call device held by the user and coupled to the client terminal indicated by the presence information of the coupling destination information.

11. A client server which is controlled remotely from a client terminal in a thin client system, and which is capable of communicating with a management server for managing calls between a communication terminal and a call device coupled to the client terminal, the client server comprising:
a communication interface for communicating with the client terminal and the management server;
a storage storing a terminal management table which stores the coupling destination information of the client terminal assigned to the client server itself; and
a processor executing:
an incoming call process of receiving a call coupling request made by the management server to request a call establishment process for a call between the call device coupled to the client terminal assigned to the client server itself and the communication terminal originating a call toward the call device, and causing the call device to receive the call through the client terminal; and
a call process of, upon receipt of a call answer from the call device in response to the incoming call through the client terminal, notifying the communication terminal of the coupling destination information of the client terminal read from the terminal management table through the management server, and establishing a call between the call device and the communication terminal.

12. A client terminal which remotely controls a client server in a thin client system, and which is capable of communicating with a call device held by a user, comprising:
a communication interface for communicating with the call device;
a storage; and
a processor, wherein
the processor executes;
a presence detection process of detecting the presence of the user by communicating with the call device held by the user and by acquiring presence information including a user ID stored in the call device, and then storing the presence information in the storage; and
a presence transmission process of reading the presence information of the user detected by the presence detection from the storage, generating presence information including the presence information of the user, and also including the ID of the client terminal itself which has detected the presence, and transmitting the generated information to the management server.

13. A call device capable of communicating with a client terminal which remotely controls a client server in a thin client system, comprising:
a communication interface for communicating with the client terminal;
a storage storing a user ID of the call device; and
a processor executing:
a process of transmitting the user ID stored in the storage to the client terminal as presence information when communicating with the client terminal;
a process of outputting an incoming call notice to a predetermined output interface upon receipt of an incoming call process by the client server through the client terminal;
a process of receiving an instruction for a call answer in response to the incoming call from an input interface, and returning information on the call answer to the client terminal; and
a process of executing the transmission and reception of call data from and to a communication terminal if a call is established with the communication terminal that has originated the incoming call.
